(19) United States
(12) Patent Application Publication
(10) Pub. No.: US 2008/0150874 A1
(43) Pub. Date: Jun. 26, 2008

(54) Flat Display and Method for Driving Flat Display

(75) Inventors: Yoshitoshi Kida, Kanagawa (JP); Yoshiharu Nakajima, Kanagawa (JP); Akira Sakaigawa, Kanagawa (JP); Koji Noguchi, Kanagawa (JP)

Correspondence Address: RADER FISHMAN & GRAUER PLLC, LION BUILDING, 1233 20TH STREET N.W., SUITE 501, WASHINGTON, DC, 20036, US

(73) Assignee: SONY CORPORATION, Tokyo (JP)

(21) Appl. No.: 11/659,957

(22) PCT Filed: Jul. 22, 2005
(86) PCT No.: PCT/JP05/13902

§ 371 Date: Jun. 6, 2007

(30) Foreign Application Priority Data
Aug. 20, 2004 (JP) 2004-240435

(51) Int. Cl. G09G 3/36

(52) U.S. Cl. 345/100

(57) ABSTRACT

The present invention is applied to e.g. a liquid crystal display. In the present invention, a plurality of signal lines are driven based on time division, and a part of voltage-dividing resistors used for generation of reference voltages V0 to V63, namely, resistors R0 and R54 to R63, is switched in linkage with this time-division driving.

### BACKGROUND OF INVENTION

1. Technical Field

The present invention relates to a flat display and a method for driving a flat display, and can be applied to e.g. a liquid crystal display. According to the present invention, plural signal lines are driven based on time division, and a part of voltage-dividing resistors used for generation of reference voltages is switched in linkage with this time-division driving. This feature offers enhanced accuracy of white balance compared with in conventional displays with effectively avoiding increases in the chip area and power consumption.

2. Background Art

In recent years, liquid crystal displays, which are flat displays applied to portable terminal devices such as PDAs and cell phones, are configured so that reference voltages of plural channels are selected depending on image data to thereby produce drive signals for the respective signal lines.

Specifically, as shown in FIG. 1, in a liquid crystal display 1, each pixel P is formed of a liquid crystal cell 2, a poly-silicon TFT (Thin Film Transistor) 3 as a switching element for the liquid crystal cell 2, and a storage capacitor. The pixels P are arranged in a matrix so that a display part 4 is formed. In the display part 4, the pixels P are provided with, for example in stripe, a color filter formed of red, green and blue cells that are sequentially and cyclically arranged. In the liquid crystal display 1, the respective pixels P of the display part 4 are connected to a horizontal drive circuit 5 and a vertical drive circuit 6 via signal lines (column lines) SIG and gate lines (row lines) G, respectively. The pixels P are sequentially selected on a line basis by the vertical drive circuit 6, and the respective signal lines SIG are driven by drive signals from the horizontal drive circuit 5. Thereby, the gray scales of the pixels P are defined.

For this operation, through processing of various operation reference signals output from a timing generator (not shown), the vertical drive circuit 6 outputs selection signals to the gate lines G in the display part 4 in synchronous with image data D1 (DR, DG, DB) used for displaying, to thereby select the pixels P on a line basis sequentially.

To the horizontal drive circuit 5, the image data D1 composed of red, green and blue color data DR, DG and DB are input in the order of e.g. the raster scanning. These image data D1 are sequentially and cyclically sampled by latch circuits (SL) 8 and output therefrom, and thereby each image data D1 is distributed to the corresponding signal line SIG. In the horizontal drive circuit 5, a reference voltage generation circuit 10 divides a predetermined produced reference voltage by resistors to thereby generate reference voltages V0 to V63 on plural channels. Reference voltage selectors 9 that are each provided for a respective one of the signal lines SIG each select one of the reference voltages V0 to V63 on plural channels depending on the image data output from the corresponding latch circuit 8. Thereby, the horizontal drive circuit 5 produces drive signals through digital/analog conversion of the image data D1, and outputs each of the drive signals to the corresponding signal line SIG via a buffer circuit 11 provided for the signal line SIG.

In the conventional liquid crystal display 1, the reference voltage generation circuit 10 is used in common to the red, green, and blue image data D1 (DR, DG, DB), and thereby simplification of the entire configuration is intended.

In a liquid crystal display panel, it is inevitable that, as shown in FIG. 2, the change of the transmittance as a function of the applied voltage is slightly different among red, green and blue pixels R, G and B. Therefore, as shown in FIG. 3, white balance involves an error at intermediate gray scales although the completely proper white balance is ensured when the transmittance is 100[%]. In addition, a backlight formed of white light-emitting diodes inevitably involves variation in the color temperature. Hence, in the case of this kind of backlight, white balance subtly varies among products even when the transmittance is 100[%].

Accordingly, conventional liquid crystal displays problematically involve insufficiency for practical use regarding the accuracy of white balance.

As one solution to this problem, a method would be available in which dedicated reference voltage generation circuits are individually provided for each of the red, green and blue image data D1 (DR, DG, DB). However, in the case of this method, the provision of the dedicated reference voltage generation circuits correspondingly lead to an increase in the chip area for layout of the reference voltage generation circuitry. Furthermore, each of the reference voltages on three channels generated by the respective reference voltage generation circuits must be led to the corresponding reference voltage selectors. Therefore, the chip area for the lead lines for the reference voltages is also increased. Accordingly, this method involves difficulty in offering a narrow frame configuration and involves increased power consumption.

For this case, if a lead line for the reference voltages is time-divided so as to be assigned to the respective colors for construction of a single-channel reference voltage configuration, the increase in the chip area can be prevented. However, in this method, the provision of the configuration for switching the assignment of the lead line based on time division results in increases in the chip area and hence power consumption after all.

As another solution, a method like one disclosed in Japanese Patent Laid-open No. 2003-333863 would be also available in which the logical values of image data are corrected on each color basis to thereby correct such distortion of white balance. However, in this method, the provision of the configuration for correcting logical values correspondingly leads to increases in the circuit area and hence power consumption. Furthermore, it is difficult for this method to eventually correct white balance with an accuracy higher than the resolution of the reference voltages V0 to V63. Moreover, the image quality is deteriorated due to so-called gray scale loss.

### DISCLOSURE OF INVENTION

The present invention is made in view of the above-described problem, and is to propose a flat display and a method for driving a flat display that can enhance the accuracy of white balance compared with in conventional displays with effectively avoiding increases in the chip area and power consumption.

In order to solve the problem, the present invention is applied to a flat display. In the flat display, for at least two kinds of a plurality of kinds of color data, a horizontal drive circuit outputs drive signals output from reference voltage selectors with switching the output destinations of the drive signals so that a plurality of signal lines are driven based on time division. Furthermore, the horizontal drive circuit switches the reference voltages through switching of a part of voltage-dividing resistors of a series circuit in linkage with switching of the output destinations of the drive signals.

According to the configuration of the present invention, the invention is applied to a flat display. For at least two kinds of a plurality of kinds of color data, a horizontal drive circuit outputs drive signals output from reference voltage selectors with switching the output destinations of the drive signals so that a plurality of signal lines are driven based on time division. Furthermore, the horizontal drive circuit switches the reference voltages through switching of a part of voltage-dividing resistors of a series circuit in linkage with switching of the output destinations of the drive signals. Due to this configuration, white balance can be defined by switching the reference voltages e.g. on each color basis merely through switching of the voltage-dividing resistors. This can offer enhanced accuracy of white balance compared with in conventional displays with effectively avoiding the increases in the chip area and power consumption.

Furthermore, the present invention is applied to a method for driving a flat display. The method includes the steps of outputting drive signals to a plurality of signal lines of a display part with switching the output destinations of the drive signals so that the plurality of signal lines are driven based on time division, and switching reference voltages through switching of a part of voltage-dividing resistors of a series circuit in linkage with switching of the output destinations of the drive signals.

Thus, the configuration of the present invention can provide a method for driving a flat display that can enhance the accuracy of white balance compared with in conventional displays with effectively avoiding increases in the chip area and power consumption.

According to the present invention, the accuracy of white balance can be enhanced compared with in conventional displays with effectively avoiding increases in the chip area and power consumption.

### BRIEF DESCRIPTION OF DRAWINGS

FIG. 1 is a block diagram showing a conventional liquid crystal display.

FIG. 2 is a characteristic curve diagram showing the relationship between transmittance and applied voltage.

FIG. 3 is a characteristic curve diagram showing the relationship between transmittance and gray scale.

FIG. 4 is a block diagram showing a liquid crystal display according to a first embodiment of the present invention.

FIG. 5 is a timing chart for explaining the operation of a reference voltage generation circuit in the liquid crystal display of FIG. 4.

FIG. 6 is a block diagram showing the reference voltage generation circuit in the liquid crystal display of FIG. 4.

FIG. 7 is a characteristic curve diagram for explaining correction for intermediate gray scales by the reference voltage generation circuit of FIG. 6.

FIG. 8 is a characteristic curve diagram for explaining correction of variation in a backlight by the reference voltage generation circuit of FIG. 6.

FIG. 9 is a characteristic curve diagram showing the correction range corresponding to the characteristic of FIG. 8.

FIG. 10 is a block diagram showing a liquid crystal display according to a second embodiment of the present invention.

FIG. 11 is a block diagram showing a liquid crystal display according to a third embodiment of the present invention.

FIG. 12 is a block diagram showing a liquid crystal display according to a fourth embodiment of the present invention.

FIG. 13 is a block diagram showing a horizontal drive circuit applied to a liquid crystal display according to a fifth embodiment of the present invention.

FIG. 14 is a characteristic curve diagram for explaining another embodiment of the present invention.

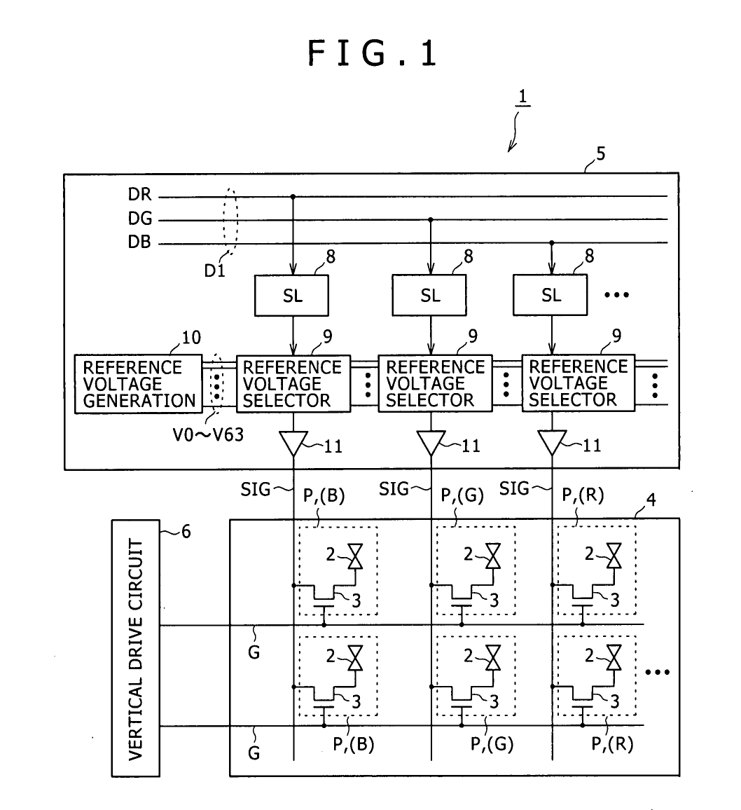

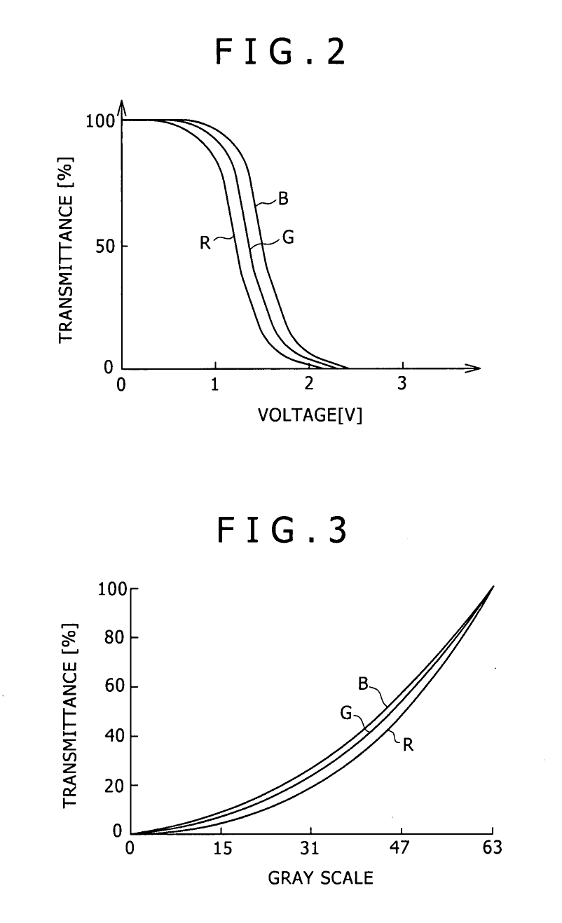

### BEST MODE FOR CARRYING OUT THE INVENTION

Embodiments of the present invention will be described in detain below with reference to the accompanying drawings.

### (1) Configuration of First Embodiment

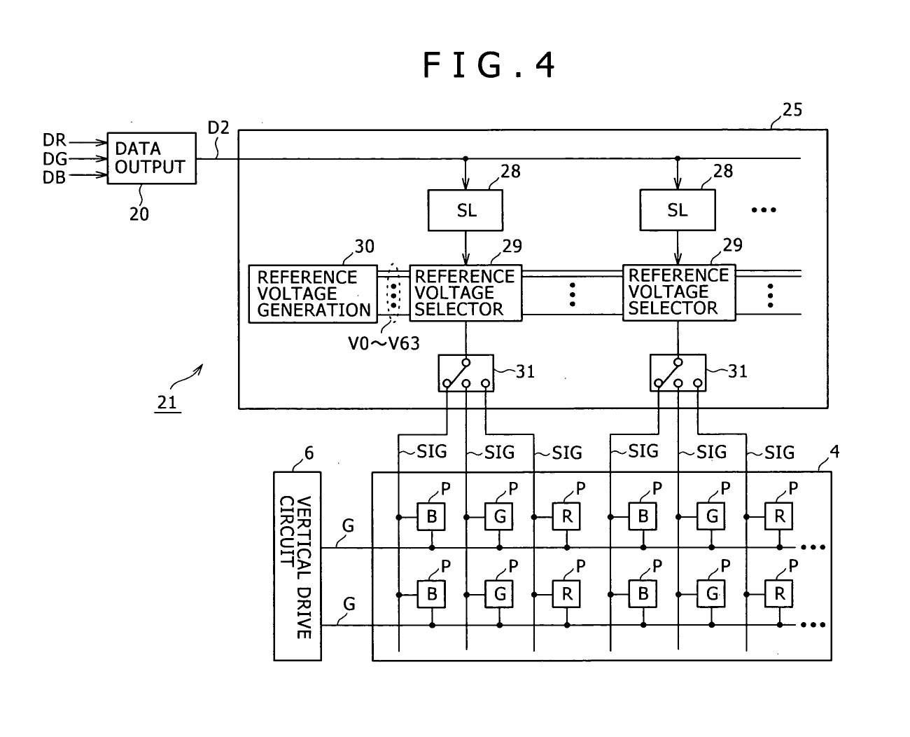

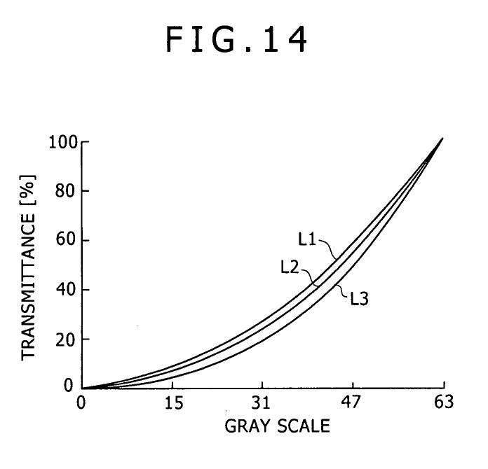

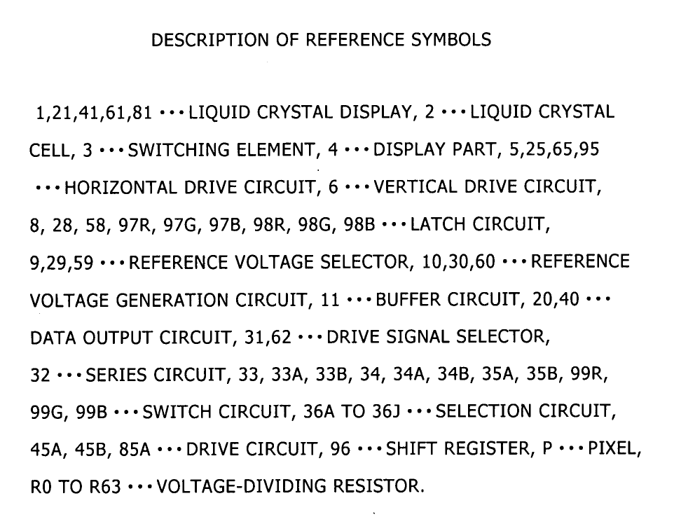

FIG. 4 is a block diagram showing a liquid crystal display according to an embodiment of the present invention. In a liquid crystal display 21, color images based on red, green and blue color data DR, DG and DB are displayed on a display part 4. In the liquid crystal display 21 of this first embodiment, the same components as those in the liquid crystal display 1 described with FIG. 14 are given the same numerals, and overlapping description thereof will be omitted.

Specifically, in this liquid crystal display 21, the display part 4 is formed based on a stripe pattern in which blue, green and red pixels B, G and R are sequentially and cyclically arranged in the horizontal direction. Therefore, the display part 4 is formed of the pixels in a plurality of groups, each of the groups being composed of the blue, green and red pixels B, G and R that are continuously arranged in the horizontal direction. In the liquid crystal display 21, color data DR, DG and DB that are each composed of 6-bits and indicate the gray scales of the red, green and blue pixels R, G and B are input to a data output circuit 20 in the order of the raster scanning.

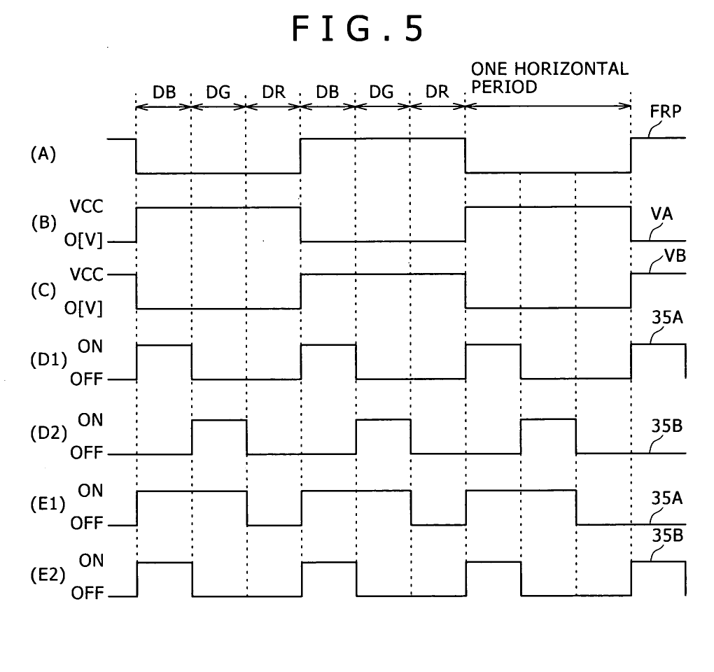

The data output circuit 20 subjects the blue, green and red color data DB, DG and DR to time division multiplexing and outputs the multiplexed data on a line basis. Specifically, the data output circuit 20 executes time division multiplexing as shown in FIG. 5 and thus outputs the resultant image data D2. More specifically, as shown in FIG. 5, each horizontal scanning period is divided into three legs. In the beginning leg, the blue color data DB of the corresponding horizontal scanning period is continuously output. In the subsequent middle leg, the green color data DG of this horizontal scanning period is continuously output. In the last leg, the red color data DR of this horizontal scanning period is continuously output.

A horizontal drive circuit 25 sequentially drives signal lines SIG connected to the red, green and blue pixels R, G and B based on time division in linkage with the time division multiplexing of the color data DR, DG and DB of the image data D2. Specifically, in the horizontal drive circuit 25, latch circuits 28 sample and output the image data D2 sequentially and cyclically, to thereby distribute the sequentially input image data D2 into the signal lines SIG of the respective groups.

Each of reference voltage selectors 29 selects one of reference voltages V0 to V63 output from a reference voltage generation circuit 30 depending on the image data D2 output from the latch circuit 28, and outputs the selected voltage. Thereby, the reference voltage selectors 29 produce and output drive signals arising from time division multiplexing of drive signals relating to the red, green and blue pixels R, G and B.

Each of drive signal selectors 31 outputs the drive signal output from the reference voltage selector 29 with switching the output destination thereof to one of the signal lines SIG relating to the red, green and blue pixels R, G and B of the respective groups. In this manner, the horizontal drive circuit 25 sequentially selects the reference voltages V0 to V63 output from one reference voltage generation circuit 30 depending on the red, green and blue pixel data DR, DG and DB to thereby define the gray scales of the corresponding pixels R, G and B.

In this first embodiment, the reference voltages V0 to V63 are generated by the reference voltage generation circuit 30, and these reference voltages V0 to V63 are switched on each color basis.

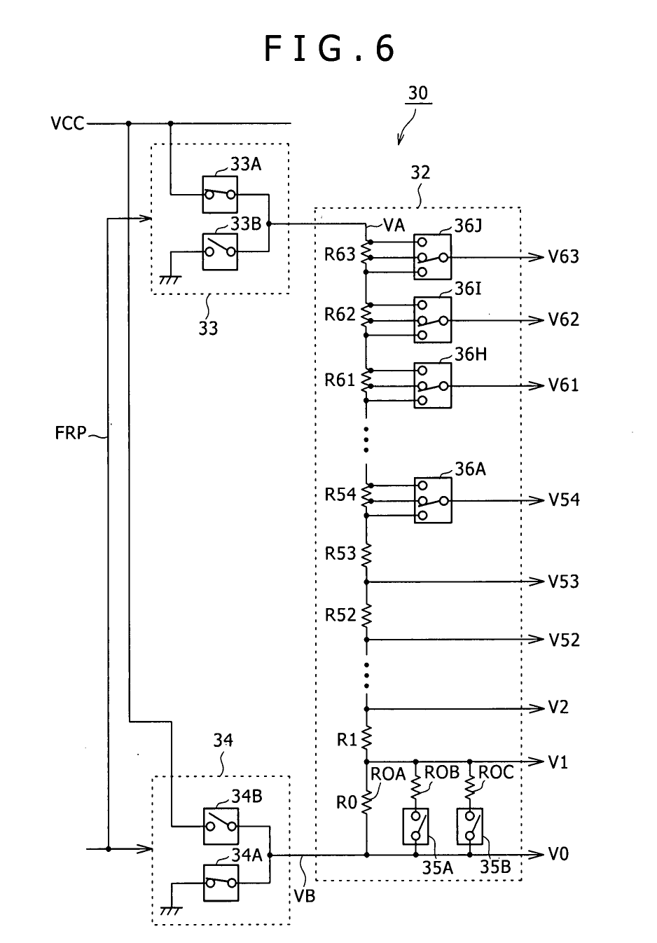

FIG. 6 is a block diagram showing the configuration of the reference voltage generation circuit 30. The reference voltage generation circuit 30 divides produced reference voltages VA and VB by a series circuit 32 of voltage-dividing resistors R0 to R63, to thereby generate the plural reference voltages V0 to V63. In this embodiment, the liquid crystal display 21 drives the display part 4 based on so-called line inversion driving. Therefore, in the reference voltage generation circuit 30, the polarities of the produced reference voltages VA and VB are switched by switch circuits 33 and 34 at every horizontal scanning period.

Specifically, in the switch circuit 33, one end of a switch circuit 33A and one end of a switch circuit 33B are connected to a source reference voltage VCC and a ground line, respectively. The on-state and off-state of the switch circuits 33A and 33B are switched in a complementary manner by a switch signal FRP (FIG. 5(A)) of which logical value is inverted at every horizontal scanning period as shown in FIG. 5. The produced reference voltage VA is output from the other ends of the switch circuits 33A and 33B (FIG. 5(B)). In the switch circuit 34, one end of a switch circuit 34A and one end of a switch circuit 34B are connected to the ground line and the source reference voltage VCC, respectively. The on-state and off-state of the switch circuits 34A and 34B are switched in a complementary manner by the switch signal FRP. The produced reference voltage VB is output from the other ends of the switch circuits 34A and 34B (FIG. 5(C)).

The series circuit 32 is formed by connecting the plural voltage-dividing resistors R0 to R63 in series to each other. The produced reference voltages VA and VB are input to both the ends of the series circuit 32. The series circuit 32 switches a part of these voltage-dividing resistors R0 to R63 to thereby switch the reference voltages V0 to V63 on each color basis.

Specifically, in the series circuit 32, the voltage-dividing resistors R0 to R63 are provided in the same number as that of the reference voltages V0 to V63. As the reference voltage V0 corresponding to the lowest gray scale, the produced reference voltage VB output from the switch circuit 34 is directly output as it is. As the reference voltage V63 corresponding to the highest gray scale, the voltage resulting from the division by the voltage-dividing resistors R0 to R63 is output.

The series circuit 32 switches the resistance value of the resistor R0 on the lowest gray scale side, to thereby change the reference voltages V1 to V63 relative to the reference voltage V0 corresponding to the lowest gray scale so that the gamma value is changed. Specifically, in the series circuit 32, the resistor R0 on the lowest gray scale side is formed of a resistor R0A and resistors R0B and R0C that are connected in parallel to the resistor R0A through switch circuits 35A and 35B, respectively. Based on this configuration, the resistance value of the resistor R0 is switched through control of the on-state and off-state of the switch circuits 35A and 35B.

In the series circuit 32, these switch circuits 35A and 35B are turned on and off as shown in FIGS. 5(D1) and 5(D2) or FIGS. 5(E1) and 5(E2) by a predetermined control signal in association with the multiplexing of the color data. Thus, the reference voltages V1 to V63 other than the reference voltage V0 are switched in linkage with the switching of the color data of the image data D2. In the example of FIGS. 5(D1) and 5(D2), the switch circuits 35A and 35B are set to the on-state in the periods for outputting of the blue and green color data DB and DG, respectively. In the example of FIGS. 5(E1) and 5(E2), both the switch circuits 35A and 35B are set to the on-state in the period for outputting of the blue color data DB, while only the switch circuit 35A is set to the on-state in the period for outputting of the green color data DG.

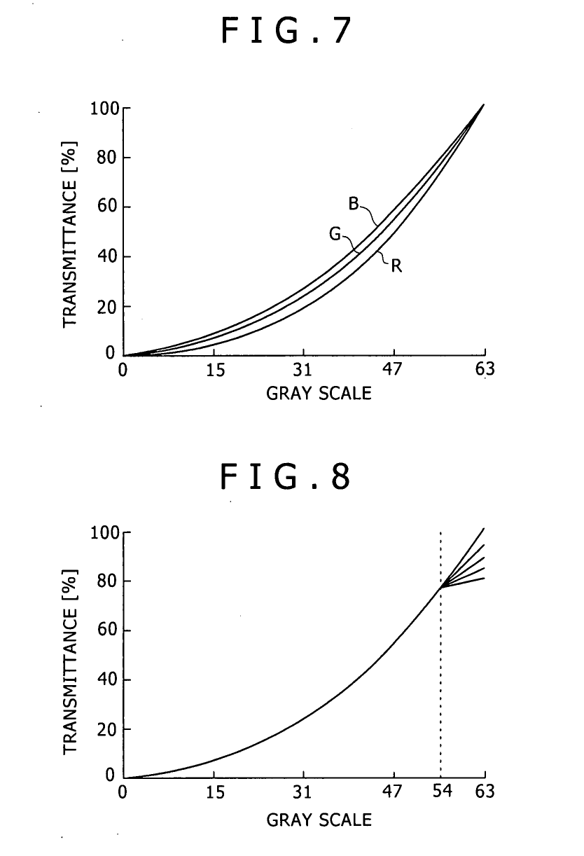

In the liquid crystal display 21, under control by a controller (not shown), the turning on and off of the switch circuits 35A and 35B are executed based on predefined setting. Thereby, as shown in FIG. 7, the gamma values for blue and green are corrected so as to be brought closer to the gamma value for red, so that the accuracy of white balance at intermediate gray scales is enhanced.

In addition, in the series circuit 32, a tap is provided for each of the voltage-dividing resistors R54 to R63, which relate to the reference voltages V54 to V63 corresponding to ten gray scales from the highest gray scale. The reference voltages V54 to V63 are output through selection of the taps by selection circuits 36A to 36J. The series circuit 32 is controlled so that these selection circuits 36A to 36J select predetermined contact points in association with the multiplexing of the color data. Due to this, the reference voltages V54 to V63 on the higher gray scale side are switched in linkage with the switching of the color data of the image data D2. Thus, in this embodiment, as shown in FIG. 8, white balance can be adjusted in various manners at the 54-th gray scale and higher gray scales, of the total 64 gray scales of the display part 4. The characteristics shown in FIG. 8 correspond to examples where the reference voltages V54 to V63 are defined so that the transmittance becomes 100[%], 95[%], 90[%], 85[%], and 80[%], respectively, at the highest gray scale.

In this embodiment, under control by the controller (not shown), the selection circuits 36A to 36J are controlled so as to select on each color basis the contact points determined depending on correction data set in the controller. For the liquid crystal display 21, the correction data are defined in adjustment operation at the time of factory shipment so that variation in the color temperature of the backlight is corrected. In the liquid crystal display 21, the primary light source of this backlight is formed of white light-emitting diodes. Thus, in the liquid crystal display 21, variation in the color temperature of the backlight is corrected, so that the accuracy of white balance is enhanced.

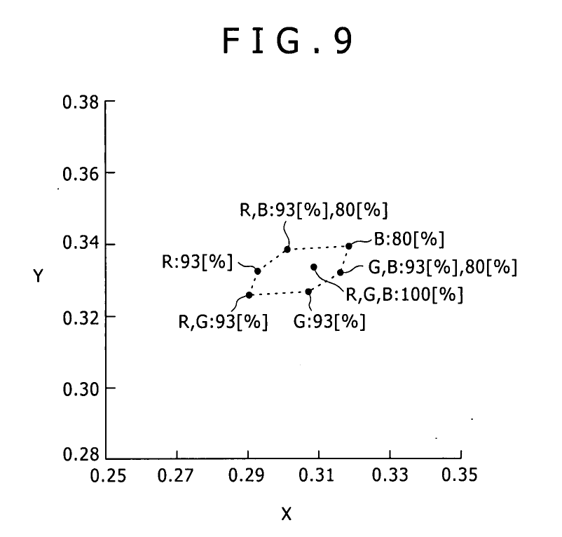

FIG. 9 is a characteristic curve diagram showing an example of the correction range for the color temperature. This correction range corresponds to a case where the luminance of blue, green, and red is changed in the range of 100 to 80[%], 100 to 93[%], and 100 to 80[%], respectively, at the highest gray scale. If variation in the color temperature of a white light-emitting diode is represented on this characteristic curve diagram, the variation ranges from the upper-right side to the lower-left side of the diagram. This makes it apparent that in the correction range example shown in FIG. 9, the variation in the color temperature of a white light-emitting diode can be corrected in a wide range. If variation in the color temperature is thus corrected, the luminance level is correspondingly lowered. However, in practice, the degree of the luminance level lowering is as low as about 9[%] according to calculation. Of white light-emitting diodes, diodes of which emission color is yellow require a high degree of the color temperature correction. Such diodes of which emission color is yellow however have a characteristic that the luminance thereof is high. Therefore, even if variation in the color temperature is thus corrected, the degree of the luminance level lowering can be kept within a range that offers sufficient luminance for practical use.

In the liquid crystal display 21 of this embodiment, the horizontal drive circuit 25 and a vertical drive circuit 6 are provided on a glass substrate that is the insulating substrate on which the display part 4 is formed, in such a manner as to be integrated with the display part 4 and disposed on the periphery of the display part 4. This allows the liquid crystal display 21 to have a so-called narrow frame configuration.

### (2) Operation of First Embodiment

According to the above-described configuration, in the liquid crystal display 21, the pixels in the display part 4 are sequentially selected by the vertical drive circuit 6 on a line basis in synchronous with image data composed of the red, green and blue color data DR, DG and DB. Furthermore, the respective signal lines SIG are driven by the horizontal drive circuit 25 depending on the image data. These operations allow color images based on the image data to be displayed on the display part 4.

In this liquid crystal display 21, the image data composed of these red, green and blue color data DR, DG and DB are input to the data output circuit 20 in advance. In the data output circuit 20, the input image data are subjected to time division multiplexing on a line basis, followed by being input to the horizontal drive circuit 25 as the image data D2. In the horizontal drive circuit 25, the image data D2 are sampled by the latch circuits 28 and distributed to the corresponding signal lines SIG sequentially and cyclically. Subsequently, the reference voltage selectors 29 each select one of the reference voltages V0 to V63 depending on the distributed image data D2, to thereby produce the drive signals for the signal lines SIG. The drive signals are distributed to the corresponding signal lines SIG by the drive signal selectors 31. Due to these operations, the pixels of the respective colors are driven based on time division, so that color images are displayed.

In the liquid crystal display 21, the signal lines SIG of the respective colors are driven based on time division as described above. In addition, the reference voltages V0 to V63 are switched by the reference voltage generation circuit 30 in linkage with the switching of the color data. Thus, in this embodiment, the reference voltages V0 to V63 can be defined on each color basis, which can offer enhanced accuracy of white balance compared with in conventional displays.

In this embodiment, the produced reference voltages VA and VB are divided by the voltage-dividing resistors R0 to R63 so that the reference voltages V0 to V63 are generated. The switching of these reference voltages V0 to V63 is executed through switching of a part of the voltage-dividing resistors R0 to R63, namely, the resistors R0 and R54 to R63. This feature can enhance the accuracy of white balance with a smaller chip area, with effectively avoiding an increase in power consumption, compared with in a configuration in which reference voltage generation circuits are individually provided for each color. Furthermore, the accuracy can be enhanced with a simpler configuration compared with in a configuration that corrects white balance through correction of image data. In addition, image quality deterioration due to gray scale loss can also be effectively avoided.

Specifically, in this embodiment, of the voltage-dividing resistors R0 to R63, the resistance value of the resistor R0 on the lowest gray scale side is switched on each color basis. Thereby, the reference voltages V0 to V63 are switched, which prevents the distortion of white balance at intermediate gray scales. In addition, switching of taps is carried out for the voltage-dividing resistors R54 to R63 on the higher gray scale side of all the voltage-dividing resistors R0 to R63, and thus only the reference voltages V54 to V63 on the higher gray scale side are switched. Due to this operation, only the gray scales of the respective colors on the higher luminance side are corrected, which corrects variation in the color temperature of the backlight. The above-described features allow this embodiment to prevent the distortion of white balance at intermediate gray scales and the distortion of white balance due to variation in the backlight, and hence have greatly enhanced accuracy of white balance compared with conventional displays.

### (3) Advantageous Effects of First Embodiment

According to the above-described configuration, plural signal lines are driven based on time division, and a part of voltage-dividing resistors used for generation of the reference voltages V0 to V63, namely, the resistors R0 and R54 to R63, is switched in linkage with this time-division driving. This feature can offer enhanced accuracy of white balance compared with in conventional displays with effectively avoiding increases in the chip area and power consumption.

Specifically, the red, green and blue color data DR, DG and DB are subjected to time division multiplexing on a line basis, and signals are output from the reference voltage selectors 29 with the output destinations of the signals being sequentially and cyclically switched to the respective signal lines SIG relating to the red, green and blue pixels. Furthermore, the partial voltage-dividing resistors R0 and R54 to R63 are switched for each of these three kinds of color data. This can enhance the accuracy of the white balance among these three kinds of color data.

Because the switching of the voltage-dividing resistors includes the switching of the resistance value of the voltage-dividing resistor R0 on the lowest gray scale side, the accuracy of white balance at intermediate gray scales can be enhanced.

Furthermore, because the switching of the reference voltages through the switching of the voltage-dividing resistors includes the switching of the plural reference voltages V54 to V63 on the higher gray scale side through switching of taps, variation in the backlight can be corrected to enhance the accuracy of white balance.

### (4) Second Embodiment

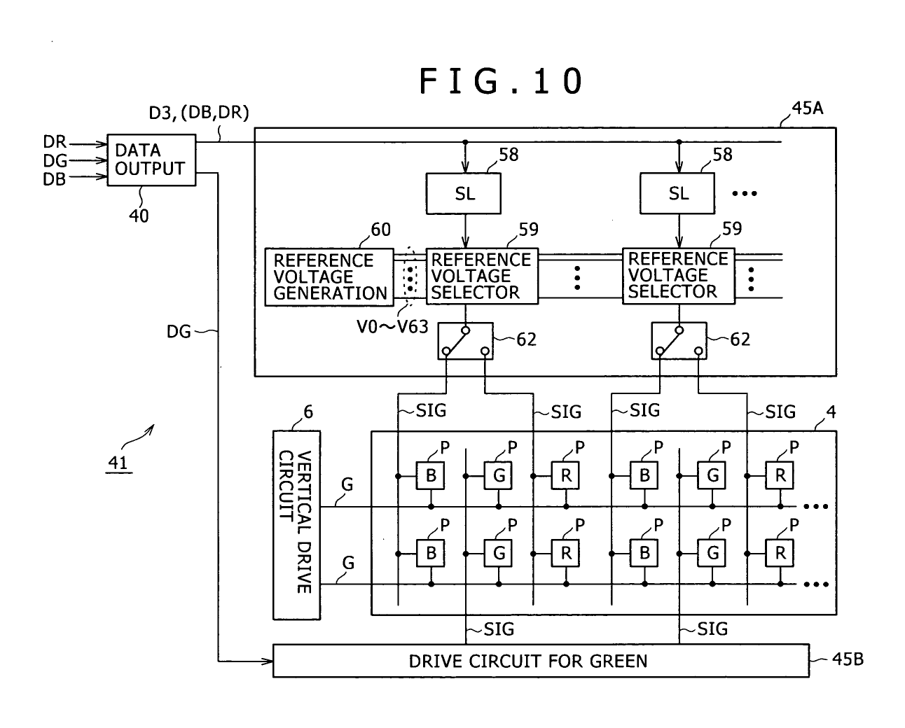

FIG. 10 is a block diagram showing a liquid crystal display according to a second embodiment of the present invention. In a liquid crystal display 41, the same components as those in the liquid crystal display 21 described with FIG. 4 are given the same numerals, and overlapping description thereof will be omitted.

In this liquid crystal display 41, a data output circuit 40 is fed with red, green and blue color data DR, DG and DB simultaneously in parallel. Of these color data, the red and blue color data DR and DB are subjected to time division multiplexing on a line basis, followed by being output as image data D3. The image data composed of the remaining color data DG is output in the order of the raster scanning.

In the liquid crystal display 41, a horizontal drive circuit is formed of a drive circuit 45A for red and blue and a drive circuit 45B for green. The red and blue drive circuit 45A outputs drive signals relating to the corresponding red and blue pixels depending on the image data D3 composed of the red and blue color data DR and DB. The green drive circuit 45B outputs drive signals relating to the green pixels depending on the image data composed of the green color data DG.

Specifically, in the red and blue drive circuit 45A, latch circuits 58 sequentially sample and output the image data D3, to thereby distribute the image data to the channels to the respective signal lines SIG. Reference voltage selectors 59 each select one of reference voltages V0 to V63 depending on the image data output from the latch circuit 58, to thereby output drive signals. Drive signal selectors 62 distribute the drive signals to the signal lines SIG relating to the red and blue pixels. A reference voltage generation circuit 60 divides produced reference voltages by voltage-dividing resistors to thereby generate and output the reference voltages V0 to V63. Furthermore, similarly to the reference voltage generation circuit 30 described above for the first embodiment, the reference voltage generation circuit 60 switches the reference voltages V0 to V63 between the voltages for red and those for blue.

In the green drive circuit 45B, built-in latch circuits sequentially sample the image data D3 and contribute the image data to the channels to the respective signal lines SIG. Reference voltage selectors subsequent to the latch circuits each select one of the reference voltages V0 to V63 to thereby produce drive signals. The drive signals drive the corresponding signal lines SIG. The reference voltages V0 to V63 are generated by a built-in reference voltage generation circuit.

According to the above-described features, in this embodiment, the reference voltages V0 to V63 are switched through switching of a part of the voltage-dividing resistors in linkage with driving of plural signal lines based on time division. Specifically, two of three kinds of color data are subjected to time division multiplexing on a line basis, and the reference voltages V0 to V63 are switched between the voltages for one of the two kinds of color data and those for the other. This feature offers enhanced accuracy of white balance compared with in conventional displays with effectively avoiding increases in the chip area and power consumption. Furthermore, this feature allows a decrease in the entire operation speed, and thus allows the respective active elements to be composed of e.g. low-temperature poly-silicon so that color images can be surely displayed.

By thus subjecting two of three kinds of color data to time division multiplexing on a line basis and switching the resistance value of the voltage-dividing resistor R0 on the lowest gray scale side, the accuracy of white balance at intermediate gray scales can be enhanced.

In addition, by thus subjecting two of three kinds of color data to time division multiplexing on a line basis and switching the reference voltages V54 to V63 through switching of taps, variation in the backlight can be corrected to enhance the accuracy of white balance.

### (5) Third Embodiment

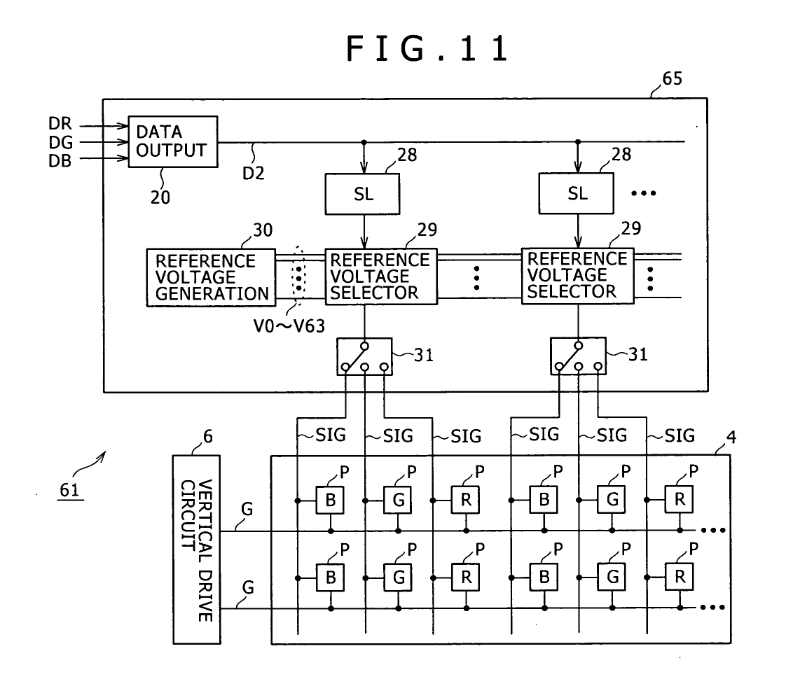

FIG. 11 is a block diagram showing a liquid crystal display according to a third embodiment of the present invention. In a liquid crystal display 61, the same components as those in the liquid crystal display 21 described with FIG. 4 are given the same numerals, and overlapping description thereof will be omitted. In the liquid crystal display 61, a display part 4, a vertical drive circuit 6, and a horizontal drive circuit 65 are formed on a glass substrate integrally with each other. The vertical drive circuit 6 and the horizontal drive circuit 65 are disposed on the periphery of the display part 4 on the glass substrate.

The horizontal drive circuit 65 is fed with red, green and blue color data DR, DG and DB simultaneously in parallel. The color data are subjected to multiplexing by a built-in data output circuit 20, followed by being output to latch circuits 28. The data output circuit 20 is formed of e.g. a semiconductor chip based on a silicon substrate. This semiconductor chip is mounted on the glass substrate serving as a part of the display part 4 in such a manner as to be disposed in the horizontal drive circuit 65.

According to this embodiment, signal lines SIG are driven by the horizontal drive circuit with the red, green and blue color data DR, DG and DB being subjected to time division multiplexing, and the data output circuit used for this time division multiplexing is incorporated in the horizontal drive circuit 65, which can further simplify the entire configuration.

### (6) Fourth Embodiment

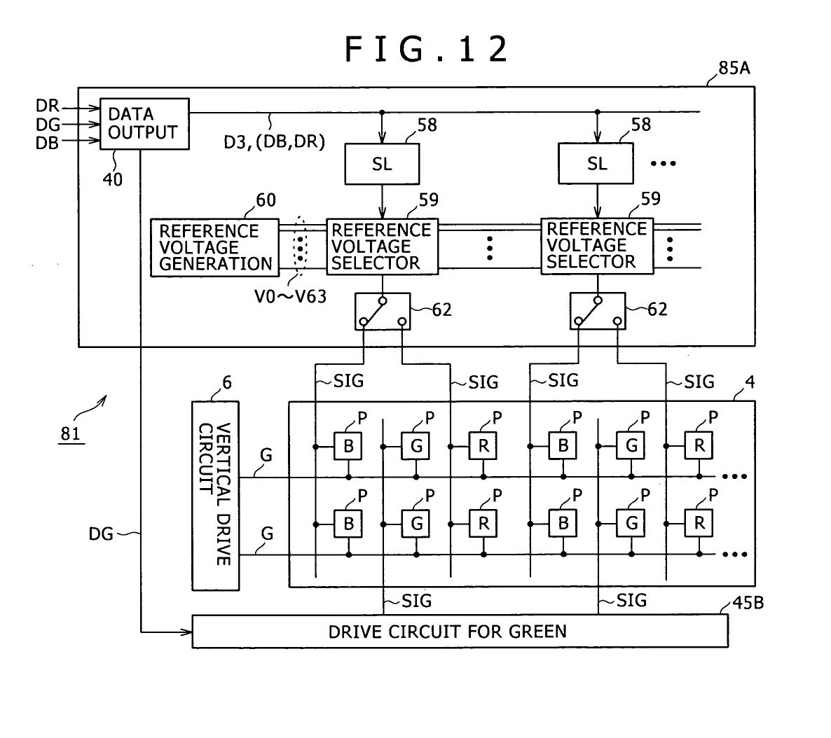

FIG. 12 is a block diagram showing a liquid crystal display according to a fourth embodiment of the present invention. In a liquid crystal display 81, the same components as those in the liquid crystal display 41 described with FIG. 10 are given the same numerals, and overlapping description thereof will be omitted. In the liquid crystal display 81, a display part 4, a vertical drive circuit 6, a drive circuit 85A for red and blue and a drive circuit 45B for green that relate to a horizontal drive circuit are formed on a glass substrate integrally with each other. The vertical drive circuit 6 and the horizontal drive circuit are disposed on the periphery of the display part 4 on the glass substrate.

The horizontal drive circuit 65 is fed with red, green and blue color data DR, DG and DB simultaneously in parallel. The red and blue color data DR and DB are subjected to multiplexing by a built-in data output circuit 40, followed by being output to latch circuits 58. The green color data DG is output to the green drive circuit 45B. The data output circuit 40 is formed of e.g. a semiconductor chip based on a silicon substrate. This semiconductor chip is mounted on the glass substrate serving as a part of the display part 4 in such a manner as to be disposed in the red and blue drive circuit 85A.

According to this embodiment, signal lines SIG are driven with the red and blue color data DR and DB being subjected to time division multiplexing, and the data output circuit used for this time division multiplexing is incorporated in the horizontal drive circuit, which can further simplify the entire configuration.

### (7) Fifth Embodiment

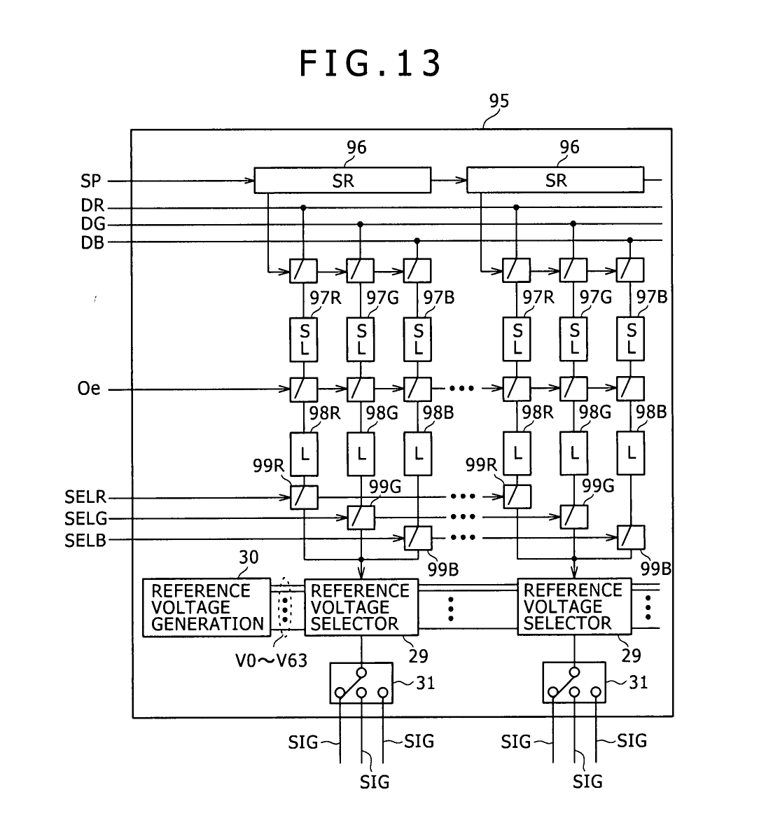

FIG. 13 is a block diagram showing a horizontal drive circuit applied to a liquid crystal display according to a fifth embodiment of the present invention. The liquid crystal display according to this embodiment is obtained by applying to the liquid crystal display 21 described above with FIG. 4 a horizontal drive circuit 95 instead of the data output circuit 20 and the horizontal drive circuit 25. In the horizontal drive circuit 95 shown in FIG. 13, the same components as those in the horizontal drive circuit 25 described with FIG. 4 are given the same numerals, and overlapping description thereof will be omitted.

This horizontal drive circuit 95 is fed with image data composed of red, green and blue color data DR, DG and DB simultaneously in parallel, and distributes the image data into corresponding signal lines SIG, followed by multiplexing for each group. Reference voltage selectors 29 each select one of reference voltages V0 to V63 depending on the multiplexed image data to thereby produce drive signals, and the signal lines SIG of the respective groups are driven by the drive signals based on time division. In linkage with this driving of the signal lines based on time division, a reference voltage generation circuit 30 switches the reference voltages V0 to V63.

Specifically, the horizontal drive circuit 95 is configured so that the red, green and blue color data DR, DG and DB are simultaneously sampled and held by corresponding latch circuits (SL) 97R, 97G and 97B in response to a sampling pulse SP output from a shift register (SR) 96. The sampling pulse SP is sequentially transferred by the shift registers 96. The latch results by the latch circuits 97R, 97G and 97B are latched and held by latch circuits (L) 98R, 98G and 98B, respectively. In this manner, the horizontal drive circuit 95 distributes the red, green and blue color data DR, DG and DB to the corresponding signal lines SIG.

Furthermore, in the horizontal drive circuit 95, the contact points of switch circuits 99R, 99G and 99B are turned to the on-state sequentially and cyclically in response to control signals SELR, SELG and SELB, respectively, so that the latch results by the latch circuits 98R, 98G and 98B are output to the reference voltage selector 29 via the switch circuits 99R, 99G and 99B, respectively. In this manner, after distributing the red, green and blue color data DR, DG and DB to the corresponding signal lines SIG, the horizontal drive circuit 95 subjects the distributed data to multiplexing and inputs the multiplexed data to the reference voltage selectors 29, to thereby drive the respective signal lines SIG based on time division.

In this embodiment, as described above, the red, green and blue color data DR, DG and DB are distributed to the corresponding signal lines SIG, and then multiplexing is executed so that the respective signal lines SIG are driven based on time division. Also in this configuration, by switching a part of voltage-dividing resistors used for generation of reference voltages in linkage with this time-division driving, the accuracy of white balance is enhanced compared with in conventional displays with effectively avoiding increases in the chip area and power consumption.

### (8) Other Embodiments

In the above-described embodiments, reference voltages are switched for each of color data relating to multiplexing. However, the present invention is not limited thereto, but reference voltages may be switched e.g. for only one of three kinds of color data relating to multiplexing as long as white balance having sufficient accuracy for practical use can be assured. Thus, by switching reference voltages for at least one of plural kinds of color data relating to multiplexing, the accuracy of white balance can be enhanced compared with in conventional displays with effectively avoiding increases in the chip area and power consumption.

Furthermore, in the above-described embodiments, white balance at intermediate gray scales is corrected through switching of the resistance value of the resistor R0 on the lowest gray scale side. However, the present invention is not limited thereto, but white balance at intermediate gray scales may be corrected through switching of the resistance value of the resistor R63 on the highest gray scale side.

In addition, in the above-described embodiments, white balance at intermediate gray scales is corrected through switching of the resistance value of only the resistor R0 on the lowest gray scale side. However, the present invention is not limited thereto, but white balance at intermediate gray scales may be corrected through switching of the resistance values of plural resistors on the lower gray scale side.

Moreover, in the above-described embodiments, the gamma values of the respective colors are matched to each other through switching of the resistance value of the resistor R0 on the lowest gray scale side. However, the present invention is not limited thereto, but the switching of the resistance value may be utilized for setting of the gamma values at intermediate gray scales as indicated by symbols L1, L2 and L3 in FIG. 14.

In addition, in the above-described embodiments, the accuracy of white balance at intermediate gray scales is enhanced, and variation in the backlight is corrected. However, the present invention is not limited thereto but may be applied to an improvement of only either one of these characteristics.

Furthermore, the above-described embodiments relate to driving of a display part based on a stripe pattern. However, the present invention is not limited thereto but can be widely applied also to driving of a display part based on e.g. a delta pattern. In the case of the delta pattern, the order of the color data relating to time division multiplexing on a line basis is switched in association with the arrangement of a color filter in the display part.

Furthermore, the above-described embodiments relate to a case where the present invention is applied to a flat display as a liquid crystal display. However, the present invention is not limited thereto but can be widely applied to various flat displays. For example, the present invention can be applied to e.g. a flat display based on organic EL.

### INDUSTRIAL APPLICABILITY

The present invention relates to a flat display and a method for driving a flat display, and can be applied to e.g. a liquid crystal display.

1. A flat display comprising:
a display part configured to include pixels arranged in a matrix;
a vertical drive circuit configured to sequentially select the pixels of the display part via gate lines; and
a horizontal drive circuit configured to produce drive signals depending on image data composed of a plurality of kinds of color data and output the drive signals to a plurality of signal lines of the display part;
wherein the horizontal drive circuit includes
a latch circuit that samples and outputs the image data sequentially and cyclically,
a reference voltage generation circuit that divides a produced reference voltage by a series circuit of voltage-dividing resistors to thereby generate a plurality of reference voltages, and
a plurality of reference voltage selectors that each select one of the plurality of reference voltages based on the image data output from the latch circuit to thereby produce the drive signal,
wherein for at least two kinds of the plurality of kinds of color data, the drive signals output from the reference voltage selectors are output with output destinations of the drive signals being switched so that the plurality of signal lines are driven based on time division, and the reference voltages are switched through switching of a part of the voltage-dividing resistors of the series circuit in linkage with switching of the output destinations of the drive signals.

2. The flat display according to claim 1,
wherein the plurality of kinds of color data are three kinds of color data as red, green and blue color data, and
the horizontal drive circuit outputs the drive signals output from the reference voltage selectors with switching output destinations of the drive signals for each kind of the three kinds of color data.

3. The flat display according to claim 1,
wherein the plurality of kinds of color data are three kinds of color data as red, green and blue color data, and
the horizontal drive circuit outputs the drive signals output from the reference voltage selectors with switching output destinations of the drive signals for two kinds of the three kinds of color data.

4. The flat display according to claim 2, wherein
switching of the voltage-dividing resistors by the reference voltage generation circuit includes switching of a resistance value of a voltage-dividing resistor on a lowest gray scale side or on a highest gray scale side.

5. The flat display according to claim 3, wherein
switching of the voltage-dividing resistors by the reference voltage generation circuit includes switching of a resistance value of a voltage-dividing resistor on a lowest gray scale side or on a highest gray scale side.

6. The flat display according to claim 2, wherein
switching of the reference voltages by the reference voltage generation circuit includes switching of a plurality of reference voltages on a higher gray scale side through switching of taps.

7. The flat display according to claim 3, wherein
switching of the reference voltages by the reference voltage generation circuit includes switching of a plurality of reference voltages on a higher gray scale side through switching of taps.

8. The flat display according to claim 1, wherein
at least the display part, the vertical drive circuit, and the horizontal drive circuit are formed integrally with each other on an insulating substrate.

9. A method for driving a flat display in which a produced reference voltage is divided by a series circuit of voltage-dividing resistors to thereby generate a plurality of reference voltages, and the plurality of reference voltages are selected to produce drive signals by which a display part that includes pixels arranged in a matrix is driven, the method comprising the steps of:
outputting the drive signals to a plurality of signal lines of the display part with switching output destinations of the drive signals so that the plurality of signal lines are driven based on time division; and
switching the reference voltages through switching of a part of the voltage-dividing resistors of the series circuit in linkage with switching of the output destinations of the drive signals.
